(19) United States
(12) Patent Application Publication
(10) Pub. No.: US 2026/0204266 A1
(43) Pub. Date: Jul. 16, 2026

(54) Artificial Intelligence Voice Authentication and Voice Control System

(71) Applicant: BENQ CORPORATION, Taipei City (TW)

(72) Inventor: Yu-Ching Tung, Taipei City (TW)

(73) Assignee: BENQ CORPORATION, Taipei City (TW)

(21) Appl. No.: 19/239,993

(22) Filed: Jun. 17, 2025

(30) Foreign Application Priority Data
Jan. 13, 2025 (TW) 114101293

(51) Int. Cl. G10L 17/18; G10L 17/10; G10L 17/22; G10L 25/63

(52) U.S. Cl. CPC G10L 17/18; G10L 17/10; G10L 17/22; G10L 25/63

(57) ABSTRACT

An artificial intelligence voice authentication system includes a client device, an artificial intelligence filter, and a Matter central control system. The client device is used to receive an input voice signal. The artificial intelligence filter is coupled to the client device and used to determine whether the input voice signal meets a predetermined condition. The Matter central control system is coupled to the artificial intelligence filter and used to generate a control signal based on the input voice signal when the input voice signal meets the predetermined condition.

### BACKGROUND OF THE INVENTION

### FIELD OF THE INVENTION

The present invention relates to an artificial intelligence voice authentication and voice control system, and more particularly, to an artificial intelligence voice authentication and voice control system for a Matter central control system.

### DESCRPTION OF THE PRIOR ART

The goal of the Matter protocol is to simplify the development costs of smart home device manufacturers and improve product compatibility. Matter has an information security design for the Internet of Things (IoT) architecture, which is safer for consumers and significantly improves the protection of personal privacy.

When the Matter specification becomes the mainstream standard for equipment manufacturers, it will form a "Matthew effect" where the winner takes all. For consumers, there will be more product options in the future. Whenever the demand for new equipment increases, as long as the consumers choose products that are Matter-certified, the new equipment will be directly compatible with the existing smart home system using Matter protocol. The consumers can enjoy the convenience of highly customized and low-cost system expansion without worrying that the original system will be eliminated by the market.

In conventional situation, closed smart home systems require a dedicated central host, which is usually the main reason for the high construction cost of smart home systems. Under Matter's standardization, more and more Wi-Fi routers that support the Thread protocol will be launched and popularized in the future. When the Wi-Fi systems in most homes support the Thread protocol, the construction cost of the smart home central host will disappear, thus reducing the overall system construction cost for consumers.

As the Matter ecosystem continues to develop and defines a general specification for IoT products, consumers can expect that in the future there will be more software and hardware companies willing to develop higher-quality, more integrated devices and services. For example, voice control systems include Alexa, Siri, Google Assistant, etc., and terminal device users can also choose brand products that they like and are reasonably priced without being bound by a single system or limited to a single platform.

However, when using the Matter central control system for voice control, it is not able to determine whether the voice source is a user in the whitelist, nor is it able to determine the user's emotional state. The Matter central control system may generate a control signal based on voice control when the wrong user is being used or when the user is under duress. In order to avoid this situation, an artificial intelligence voice control system is desired.

### SUMMARY OF THE INVENTION

An embodiment provides an artificial intelligence voice authentication system. The artificial intelligence voice authentication system includes a client device, an artificial intelligence filter, and a Matter central control system. The client device is used to receive an input voice signal. The artificial intelligence filter is coupled to the client device and used to determine whether the input voice signal meets a predetermined condition. The Matter central control system is coupled to the artificial intelligence filter and used to generate a control signal based on the input voice signal when the input voice signal meets the predetermined condition.

An embodiment provides an artificial intelligence voice control system. The artificial intelligence voice control system includes the artificial intelligence voice authentication system and a peripheral device. The peripheral device is coupled to the Matter central control system of the artificial intelligence voice authentication system and used to generate an action according to the control signal generated by the Matter central control system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an artificial intelligence voice control system according to an embodiment of the present invention.

FIG. 2 is a block diagram of another artificial intelligence voice control system according to an embodiment of the present invention.

### DETAILED DESCRIPTION

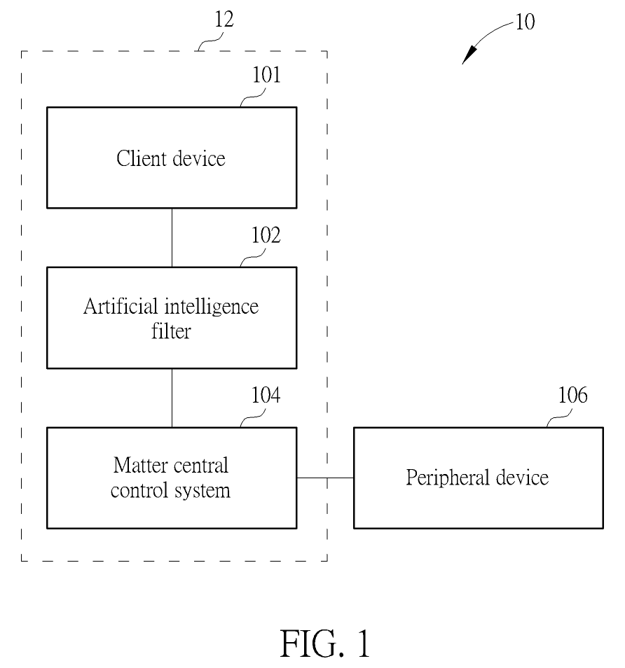

FIG. 1 is a block diagram of an artificial intelligence voice control system 10 according to an embodiment of the present invention. The artificial intelligence voice control system 10 includes an artificial intelligence voice authentication system 12 and a peripheral device 106. The artificial intelligence voice authentication system 12 includes a client device 101, an artificial intelligence filter 102, and a Matter central control system 104. The client device 101 can be coupled to the artificial intelligence filter 102 by wire or wirelessly (via Wi-Fi or Bluetooth). The client device 101 can be an independent device, such as a microphone, or can be integrated into the peripheral device 106. The Matter central control system 104 can be coupled to the artificial intelligence filter 102 and the peripheral device 106 by wire or wirelessly (via Wi-Fi or Bluetooth). The client device 101 is used to receive an input voice signal, and the artificial intelligence filter 102 is used to determine whether the input voice signal meets a predetermined condition. In one embodiment, the Matter central control system 104 includes at least one of Matter controller selected from the group consisting of smart media devices, smart home hubs, network devices, and smart mobile devices that support the Matter protocol. In one embodiment, the predetermined conditions include that the user has stable emotions and that the user is an authenticated user. The Matter central control system 104 is used to generate a control signal according to the input voice signal when the input voice signal meets the predetermined condition. The peripheral device 106 is used to generate an action according to the control signal generated by the Matter central control system 104. In one embodiment, the peripheral device 106 includes at least one of smart device selected from the group consisting of a smart light bulb, a smart speaker, a smart TV, an air conditioner, a smart refrigerator, and a smart projector. The action of the peripheral device 106 includes at least one executable instruction selected from the group consisting of turning on a switch, turning off a switch, increasing the volume, decreasing the volume, increasing the temperature, decreasing the temperature, and playing. In one embodiment, the artificial intelligence filter 102 is based on at least one of model selected from the group consisting of a convolutional neural network (CNN), a recurrent neural network (RNN), a long short-term memory model (LSTM), and an artificial neural network (ANN).

In one embodiment, the artificial intelligence filter 102 is located in a cloud system. This embodiment can send the artificial intelligence calculation to the artificial intelligence filter 102 of the cloud system for processing. The cloud system is, for example, a server in a data center. The client device 101 only needs to process the transmission of the input voice signal and the command, so that the artificial intelligence voice control system 10 has high real-time performance. In particular, the Matter central control device in a home environment needs to respond to user commands in a short time. Handing over the artificial intelligence calculation to the artificial intelligence filter 102 of the cloud system for processing can reduce the computational load and cost of the Matter central control device and bring the benefit of instant response.

In one embodiment, the user authenticated by the Matter central control system 104 is user A, and the peripheral devices 106 include an air conditioner and a smart TV. The air conditioner and the smart TV can be coupled to the Matter central control system 104 by wire (for example, via a Universal Serial Bus (USB)) or wirelessly (for example, via Wi-Fi or Bluetooth). When user B sends a voice signal "turn on the air conditioner", the client device 101 will receive the voice signal and transmit it to the artificial intelligence filter 102. The artificial intelligence filter 102 will determine that the voice source is not user A, so it filters out the input voice signal, and the Matter central control system 104 will not generate a control signal. When user A sends a voice signal "turn on the air conditioner" under a nervous emotion (perhaps under duress), the artificial intelligence filter 102 will determine that the voice source is user A, but the emotion is unstable. Therefore, the input voice signal is filtered out, and the Matter central control system 104 will not generate a control signal. When user A is in a stable emotion and sends a voice signal "turn on the air conditioner", the artificial intelligence filter 102 will determine that the voice source is user A and that the user is in a stable emotion, so the Matter central control system 104 will generate a control signal to turn on the air conditioner. When user A is in a stable emotion and sends a voice signal "turn up the air conditioner temperature", the artificial intelligence filter 102 will determine that the voice source is user A and that the user is in a stable emotion. Therefore, the Matter central control system 104 will generate a control signal to turn up the air conditioner temperature. When user A is in a stable emotion and sends a voice signal "turn down the TV volume", the artificial intelligence filter 102 will determine that the voice source is user A and that the user is in a stable emotion, so the Matter central control system 104 will generate a control signal to control the smart TV to turn down the volume.

In one embodiment, the Matter central control system 104 may allow multiple users to control the peripheral device 106, and the stable emotions corresponding to the multiple users may have different thresholds. The artificial intelligence filter 102 will determine whether different users have stable emotions based on different thresholds. If a user is allowed to control the peripheral device 106 and is judged to have stable emotions based on the threshold corresponding to the user, the user can control the peripheral device 106 through the Matter central control system 104.

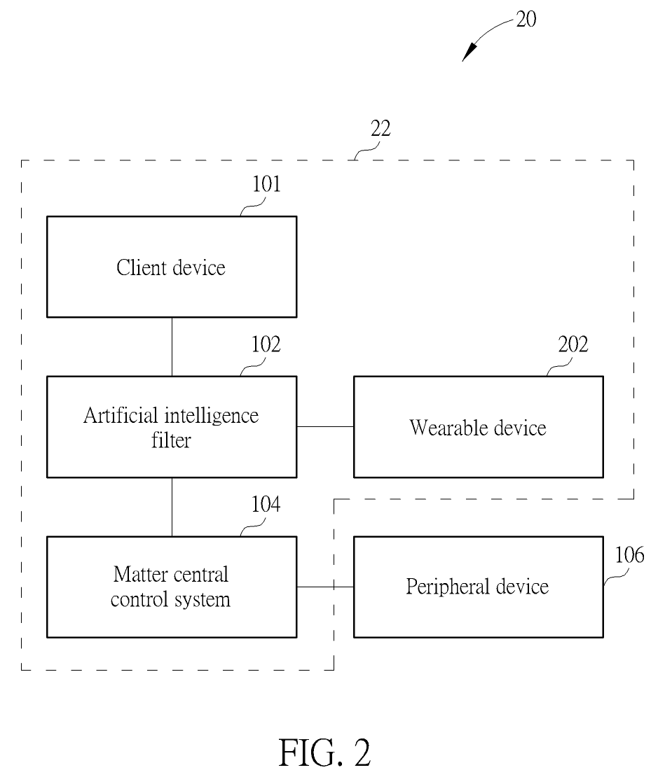

FIG. 2 is a block diagram of another artificial intelligence voice control system 20 according to an embodiment of the present invention. The artificial intelligence voice control system 20 includes an artificial intelligence voice authentication system 22 and a peripheral device 106. The artificial intelligence voice authentication system 22 includes a client device 101, a wearable device 202, an artificial intelligence filter 102 and a Matter central control system 104. The client device 101 can be coupled to the artificial intelligence filter 102 by wire or wirelessly (via Wi-Fi or Bluetooth). The client device 101 can be an independent device, such as a microphone, or can be integrated into the wearable device 202 or the peripheral device 106. The wearable device 202 can be coupled to artificial intelligence filter 102 by wire or wirelessly (via Wi-Fi or Bluetooth). In one embodiment, the wearable device 202 may be a smart watch, a smart bracelet, etc., but the present invention is not limited thereto. The Matter central control system 104 can be coupled to the artificial intelligence filter 102 and the peripheral device 106 by wire or wirelessly (via Wi-Fi or Bluetooth). The wearable device 202 is used to detect somatosensory signals, which include at least one of signal selected from the group consisting of a body temperature signal, a heartbeat signal, and a sweat signal (the sweat signal can be calculated by the sweating degree sensed by a humidity sensor). The client device 101 is used to receive an input voice signal. The artificial intelligence filter 102 is used to determine whether the somatosensory signal and the input voice signal meet predetermined conditions. In one embodiment, the Matter central control system 104 includes at least one of Matter controller selected from the group consisting of smart media devices, smart home hubs, network devices, and smart mobile devices that support the Matter protocol. In one embodiment, the predetermined conditions include that the user has stable emotions and that the user is an authenticated user. The Matter central control system 104 is used to generate a control signal according to the input voice signal when the somatosensory signal and the input voice signal meet predetermined conditions. The peripheral device 106 is used to generate an action based on the control signal generated by the Matter central control system 104. In one embodiment, the peripheral device 106 includes at least one of smart device selected from the group consisting of a smart light bulb, a smart speaker, a smart TV, an air conditioner, a smart refrigerator, and a smart projector. The action of the peripheral device 106 includes at least one of executable instruction selected from the group consisting of turning on a switch, turning off a switch, increasing the volume, decreasing the volume, increasing the temperature, decreasing the temperature, playing, etc. In one embodiment, the artificial intelligence filter 102 is based on at least one of model selected from the group consisting of a convolutional neural network (CNN), a recurrent neural network (RNN), a long short-term memory model (LSTM), and an artificial neural network (ANN).

In one embodiment, the artificial intelligence filter 102 is located in a cloud system. The embodiment can send the artificial intelligence calculation to the artificial intelligence filter 102 of the cloud system for processing. The cloud system is, for example, a server in a data center. The client device 101 only needs to process the transmission of the input voice signal and the command, and the wearable device 202 only needs to process the detection and transmission of the somatosensory signal, so that the artificial intelligence voice control system 20 has high real-time performance. In particular, the Matter central control device in a home environment needs to respond to user commands in a real-time manner. Handing over the artificial intelligence calculation to the artificial intelligence filter 102 of the cloud system for processing can reduce the computational load and cost of the Matter central control device and bring the benefit of real-time response. In some embodiments, the artificial intelligence calculation results (whether the user has passed voice authentication) can be sent back from the cloud to a wearable device (such as a smart watch), and the user can confirm the artificial intelligence processing results and the status of the peripheral device 106 through the smart watch. In another embodiment, the calculation result of artificial intelligence (whether the user passes the voice authentication) can also be sent back from the cloud to the Matter central control system 104 to generate a control signal for controlling the action of the peripheral device 106, but the present invention is not limited thereto.

In one embodiment, the user authenticated by the Matter central control system 104 is user A, and both users A and B are wearing the wearable device 202. The peripheral devices 106 include an air conditioner and a smart TV. The air conditioner and the smart TV can be coupled to the Matter central control system 104 by wire (for example, via a Universal Serial Bus (USB)) or wirelessly (for example, via Wi-Fi or Bluetooth). When user B sends a voice signal "turn on the air conditioner", the client device 101 will receive the voice signal and transmit it to the artificial intelligence filter 102. The artificial intelligence filter 102 will determine that the voice source is not user A, so it filters out the voice signal, and the Matter central control system 104 will not generate a control signal. When user A sends a sound signal "turn on the air conditioner" under a nervous emotion (possibly under duress), the artificial intelligence filter 102 will determine that the voice source is user A with unstable emotion based on the somatosensory signal sent back by the wearable device 202 and the voice signal sent back by the client device 101. However, the user A has unstable emotion, so the voice signal is filtered out, and the Matter central control system 104 will not generate a control signal. When user A is in a stable emotion and sends a voice signal "turn on the air conditioner", the artificial intelligence filter 102 will determine that the voice source is user A and that the user is in a stable emotion based on the somatosensory signal sent back by the wearable device 202 and the voice signal sent back by the client device 101, so the Matter central control system 104 will generate a control signal to turn on the air conditioner. When user A is in a stable emotion and sends a voice signal "turn up the air conditioner temperature", the artificial intelligence filter 102 will determine that the voice source is user A and that the user is in a stable emotion based on the somatosensory signal sent back by the wearable device 202 and the voice signal sent back by the client device 101, so the Matter central control system 104 will generate a control signal to control the air conditioner to turn up the temperature. When user A is in a stable emotion and sends a voice signal "turn down the TV volume", the artificial intelligence filter 102 will determine that the voice source is user A and that the user is in a stable emotion based on the somatosensory signal sent back by the wearable device 202 and the voice signal sent back by the client device 101. Therefore, the Matter central control system 104 will generate a control signal to control the smart TV to turn down the volume.

In one embodiment, during pre-training, voiceprint samples of user A and non-user A (for example, users B, C, and D) need to be collected. At the same time, the wearable device 202 collects the user's physiological characteristics, such as body temperature signal, heartbeat signal and sweat signal (the sweat signal can be calculated by the sweating degree sensed by the humidity sensor). After defining the voiceprint and physiological characteristics, a threshold (for example, 0.9) is determined. An output signal exceeding the threshold represents an authenticated user with stable emotions, while an output signal below the threshold represents an unauthenticated user or a user with an unstable emotion. By pre-marking the outputs as 1 (authenticated user with stable emotions) and 0 (not an authenticated user or emotionally unstable), the artificial intelligence filter 102 of user A can be trained. The training is performed until the emotionally stable authenticated user input samples can cause the output signal to exceed the threshold. If the emotionally stable authenticated user input samples produce an output signal less than the threshold, more samples (such as users E, F, G) are collected for further training. In one embodiment, the pre-trained thresholds may be selected by the user or established by a training engineer. Pre-trained samples can be classified as three categories: training set, testing set, and validation set. During training, the artificial intelligence model is trained through the data in the training set. During the training process, the validation set is used to judge the accuracy. Whether the accuracy of the artificial intelligence model is sufficient is determined by predicting whether the data in the validation set is greater than the threshold. When the accuracy is sufficient, predict the data of the test set to determine whether the artificial intelligence model can be applied in practical scenarios.

In summary, the embodiments of the present invention provide an artificial intelligence voice control system 10, 20, which determines whether the user is an authenticated user and whether the user is emotionally stable through voice signals and/or somatosensory signals (such as body temperature, heartbeat and/or sweating) provided by the wearable device 202, thereby determining whether to generate a control signal through the Matter central control system 104 to control the peripheral device 106 to produce an action. The artificial intelligence voice control systems 10 and 20 of the present invention provide an Internet of Things solution to make the Matter central control system 104 more secure.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An artificial intelligence voice authentication system, comprising:
a client device configured to receive an input voice signal;
an artificial intelligence filter coupled to the client device and configured to determine whether the input voice signal meets a predetermined condition; and
a Matter central control system coupled to the artificial intelligence filter and configured to generate a control signal based on the input voice signal when the input voice signal meets the predetermined condition.

2. The artificial intelligence voice authentication system of claim 1, wherein the predetermined condition comprises:
a user having stable emotions; and
the user being an authenticated user.

3. The artificial intelligence voice authentication system of claim 1, wherein the Matter central control system comprises at least one of device selected from the group consisting of a smart media device, a smart home hub, a network device, and a smart mobile device which support the Matter protocol.

4. The artificial intelligence voice authentication system of claim 1, wherein the artificial intelligence filter is based on a convolutional neural network (CNN), a recurrent neural network (RNN), a long short-term memory model (LSTM) or an artificial neural network (ANN).

5. The artificial intelligence voice authentication system of claim 1, further comprises:
a wearable device configured to detect a somatosensory signal;
wherein the artificial intelligence filter is configured to determine whether the somatosensory signal and the input voice signal meet the predetermined condition.

6. The artificial intelligence voice authentication system of claim 5, wherein the somatosensory signal comprises at least one of signal selected from the group consisting of a body temperature signal, a heartbeat signal, and a sweat signal.

7. The artificial intelligence voice authentication system of claim 1, wherein the artificial intelligence filter is located in a cloud system.

8. An artificial intelligence voice control system, comprising the artificial intelligence voice authentication system of claim 1; and
a peripheral device coupled to the Matter central control system of the artificial intelligence voice authentication system, and configured to generate an action according to the control signal generated by the Matter central control system.

9. The artificial intelligence voice control system of claim 8, wherein the peripheral device comprises at least one of device selected from the group consisting of a smart light bulb, a smart speaker, a smart television, an air conditioner, a smart refrigerator, and a smart projector.

10. The artificial intelligence voice control system of claim 8, wherein the action comprises at least one of action selected from the group consisting of turning on a switch, turning off the switch, turning up a volume, turning down the volume, turning up a temperature, turning down the temperature, and playing.
